(19) United States
(12) Patent Application Publication
(10) Pub. No.: US 2003/0006075 A1
(43) Pub. Date: Jan. 9, 2003

(54) Agricultural machine

(75) Inventor: Martin Arnold, Steinlah (DE)

Correspondence Address: Penrose Lucas Albright Esq., MASON, MASON & ALBRIGHT, P.O. Box 2246, Arlington, VA, 22202-0246, US

(73) Assignee: LELY ENTERPRISES A.G.

(21) Appl. No.: 10/184,823

(22) Filed: Jul. 1, 2002

(30) Foreign Application Priority Data
Jul. 3, 2001 (EP) 01202542.5

(51) Int. Cl. B60K 25/06

(52) U.S. Cl. 180/53.6

(57) ABSTRACT

The invention relates to an agricultural machine (1) couplable to a tractor (3) and drivable from the tractor (3) and having at least one consumer (10, 12) supplied with electrical energy. In order to ensure operational reliability of the electrical consumers (10, 12) of the agricultural machine (1) despite increasing demands, it is proposed according to the invention that, for power supply, the agricultural machine (1) comprises its own on-board electrical system (17) having at least one energy generator (13) and/or energy storage mechanism (15) of its own.

### RELATED APPLICATION

This invention relates to an agricultural machine which for operation purposes is coupled to and drivable from a tractor and which has at least one device which uses electrical energy.

### BACKGROUND OF THE INVENTION

The extent to which electronics are used in agricultural machinery is increasing markedly. Even now, balers may have up to twenty devices which consume electrical energy, referred to herein as “consumers” or “electrical consumers” for example. Examples of consumers are open-loop control, closed-loop control and operating devices which are in active connection with sensors and actuators and serve in density control, or servomotors for movement sequences, such as for example binding in the case of round balers or electrically driven fans for cleaning the twine knotters in the case of square balers.

Electronic energy supply has hitherto been provided from the tractor, by connecting supply leads to the twelve volt tractor battery or to the twenty-five amperage continuous current socket outlet of the tractor.

This is disadvantageous, on the one hand due to the voltage drop resulting from numerous, long connecting leads between the tractor and the consumers of the agricultural machine. On the other hand, however, the simultaneous actuation of a plurality of current consumers on the tractor leads to problems in the operation of the consumers on the agricultural machine such as operating too slowly or indeed to not operating at all. Moreover, the simultaneous operation of a plurality of consumers on the agricultural machine overloads the tractor power source, thereby causing fuses to blow. Open-loop and closed-loop control devices include their own regulators, which take account the possibility of voltage drop and adjust the voltage down to eight volts for example, whereby the open-loop and closed-loop control devices operate smoothly even at this voltage. Matters could be improved with thicker lead cross sections, but the tractor leads designed for twenty-five amp continuous current would still cause a considerable voltage drop.

In the future, consumers on agricultural machines, in particular balers, which are currently mechanically or hydraulically actuated will be replaced by electrical consumers.

An object of the invention is to ensure the operational reliability of electrical consumers on an agricultural machine connected to a tractor despite increasing demands.

This object is achieved according to the invention in that, for power supply, the agricultural machine has its own on-board electrical system comprising at least one energy generator or energy storage mechanism of its own, or both.

In this way, the following advantages are achieved:

The design of current intensity, lead cross sections and fuses is consumer related independent of the tractors electrical system;

A relatively high number of consumer as possible;

Reliable simultaneous operation of a plurality of consumers is provided without impact on or caused by the tractor;

Connecting lead lengths are minimized;

Voltage drops or malfunctioning due to a tractor socket outlet are avoided;

Operation with tractors which use twenty-five or forty-two volt installations, for example, are possible;

The tractor connection configuration has no impact on the agricultural machine. Because some tractor manufacturers (England) connect the positive lead to ground, it is necessary to isolate the entire electrical system from the chassis (ground), which it complex;

Because the on-board electrical system also comprises an energy storage mechanism, control processes may also be performed when the working components are at a standstill; and

Low energy consumers may also be supplied solely by a battery on the agricultural machine.

Further features and advantages of the invention will be appreciated from the following description of a preferred embodiment, with reference to the drawings, in which:

### BRIEF DESCRIPTION OF THE DRAWINGS

FIG. 1 illustrates a combination of a tractor and a round baler with its own power supply according to the invention; and

FIG. 2 is a circuit diagram of an on-board electrical system for the round baler according to FIG. 1, with a low power operating/control device and a higher power binding drive motor.

### DETAILED DESCRIPTION OF THE PREFERRED EMBODIMENTS

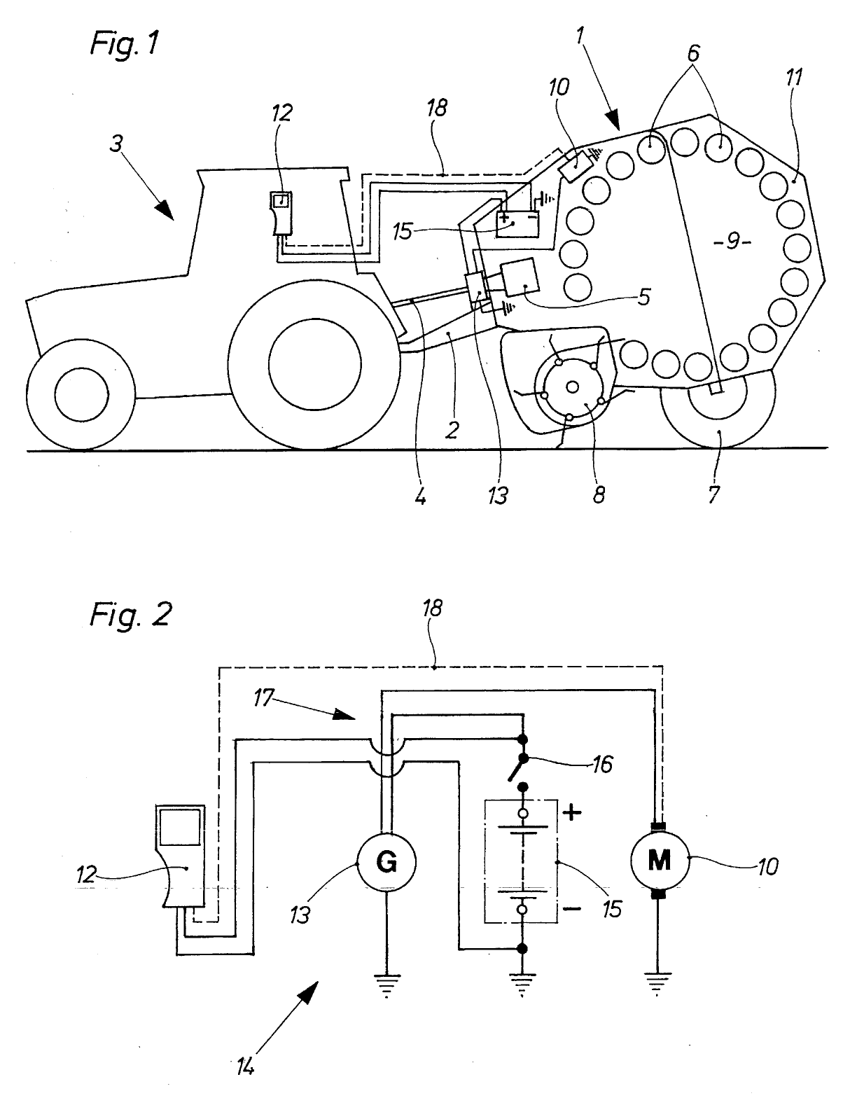

The round baler 1, which shown in FIG. 1 as a representative agricultural machine, is mobile and is connected to a tractor 3 by a drawbar 2. Tractor 3 pulls round baler 1 and provides the energy required for the functional components, for example torque from a power take-off shaft on tractor 3 via a cardan shaft 4 and a main transmission 5 to baling rollers 6 and hydraulic pressure from a hydraulic tractor pump via hydraulic lines.

Round baler 1 is mounted on a running gear 7 and has at its front end, in the direction of travel, a height-adjustable pick-up device 8, which conveys the stalk material picked up from the gerund into a baling chamber 9, in which the baling members 6 form a bale (not shown). The compressed bale is tied up by means of a binding device, of which only an electric motor 10 is shown. After being tied, the finished bale is ejected to the rear when a tailgate 11 is opened.

The novel feature is that electrical energy for consumers, such as a control device or an operating device 12 or a combination thereof and electric motor 10, on round baler 1 is no longer provided via the tractor electrical system, but rather by a separate three-phase current generator 13 arranged on round baler 1, which generator is arranged upstream of the main transmission 5 of round baler 1 and is driven mechanically from tractor 3 via cardan shaft 4. The fixed three-phase current generator 13 is connected to the input shaft of the main transmission 5 for example via a belt drive with gearing.

FIG. 2 shows an example of an on-board electrical system 14 of round baler 1. It consists of three-phase current generator 13, a battery 15, a battery master switch 16 in the form of an emergency stop safety switch, control device 12 in the form of a low-power consumer and electric motor 10 for driving the binding device together with cables 17, wherein the negative lead is connected to the baler housing as a ground in conventional manner. Electric motor 10 is connected directly to battery 15, while control device 12 is connected to battery 15. A CAN bus line 18 from control device 12 serves to control the movement sequences of electric motor 10.

The mode of operation of round baler 1 according to the invention is as follows:

During operation, the power take-off shaft of tractor 3 drives cardan shaft 4 and thus the three-phase current generator 13. By appropriate actuation of the battery master switch 16 and operating and control device 12, the switched-on consumer 10 is supplied with current via the on-board electrical system of baler 1 when the electrical circuit is closed. As hitherto, however, the lighting system of round baler 1 as prescribed by the motor vehicle safety standards obtains its energy supply and signals from tractor 3.

Instead the round baler, combinations of round balers and devices for wrapping the bale with film or indeed square balers or fertilizer spreaders, mowing mechanisms, self-loading forage boxes and other agricultural machines may also be equipped according to the invention with their own electrical energy supplies. In the case of agricultural machines having consumers, such as an open-loop or closed-loop control device, or a combination thereof, which consume only small amounts of power, it may be sufficient merely to use an energy storage mechanism, which supplies energy for at least twenty-four hours. Alternately, it may also be expedient to connect only the high-power consumers to the agricultural machine's own energy supply installation and to operated the low-power consumers from the tractor electrical system.

Although I have disclosed the preferred embodiments of my invention, it is to be understood that it is capable of other adaptations and modifications within the scope of the following claims:

1. An agricultural machine (1) couplable to a tractor (3) and drivable from the tractor (3) and having at least one consumer (10, 12) supplied with electrical energy, characterised in that, for power supply, the agricultural machine (1) comprises its own on-board electrical system (17) having at least one energy generator (13) and/or energy storage mechanism (15) of its own.

2. An agricultural machine according to claim 1, characterised in that the energy generator (13) is driven directly or indirectly by a main drive shaft (4) of the agricultural machine (1).

3. An agricultural machine according to claim 2, characterised in that gearing is provided between main drive shaft (4) and energy generator (13).

4. An agricultural machine according to claim 2 or claim 3, characterised in that the energy generator (13) is driven by an input shaft of the main transmission (5) of the agricultural machine (1).

5. An agricultural machine according to claim 4, characterised in that the energy generator (13) is driven by a belt drive.

6. An agricultural machine according to one or more of the preceding claims, characterised in that the energy generator (13) is a three-phase current generator.

7. An agricultural machine according to one or more of the preceding claims, characterised in that the energy storage mechanism (15) is a battery arranged fixedly on the agricultural machine (1), wherein between generator (13), battery (15) and consumers (10, 12) there is provided cabling (17) with at least one emergency stop switch (16), which, as a safety element, interrupts current supply to all the consumers.

8. An agricultural machine according to one or more of the preceding claims, characterised in that the agricultural machine is a baler (1), which may be combined with a means for wrapping the ejected bale in film.

9. An agricultural machine according to one or more of the preceding claims, characterised in that the lighting system of the agricultural machine (1) is supplied with energy and operated by the electrical system of the tractor (3).

10. An agricultural machine according to claim 1, characterised by electrical consumers, which may be operated solely by an energy storage mechanism.
